(19) United States
(12) Patent Application Publication
(10) Pub. No.: US 2025/0222983 A1
(43) Pub. Date: Jul. 10, 2025

(54) BODY FOR VEHICLE

(71) Applicants: Hyundai Motor Company, Seoul (KR); Kia Corporation, Seoul (KR)

(72) Inventors: Hyun Cheol Yun, Seoul (KR); Tae Gyu Park, Hwaseong-si (KR); Jin Young Mo, Hwaseong-si (KR)

(21) Appl. No.: 18/656,011

(22) Filed: May 6, 2024

(30) Foreign Application Priority Data
Jan. 10, 2024 (KR) 10-2024-0004207

(51) Int. Cl. B62D 23/00; B60J 5/04

(52) U.S. Cl. CPC B62D 23/005; B60J 5/0473

(57) ABSTRACT

A body for a vehicle capable of achieving easy and convenient assembly while reducing manufacturing costs through an improved structure thereof meeting characteristics of an unmanned delivery vehicle is disclosed. The body can be configured through inclusion of a body module including a frame assembled thereto, thereby constituting a frame of the vehicle, an exterior material configured to have a shape covering an outside of the body module, and a mounting unit mounted to the body module, for assembly of the exterior material thereto. A door of the vehicle can be installed at a position adjacent to the exterior material and pivotably connected to the mounting unit.

### CROSS-REFERENCE TO RELATED APPLICATIONS

This application claims priority from Korean Patent Application No. 10-2024-0004207 filed on Jan. 10, 2024 in the Korean Intellectual Property Office, the disclosure of which is incorporated herein by reference in its entirety.

### TECHNICAL FIELD

The present disclosure relates to a body for a vehicle.

### BACKGROUND

A body of a vehicle may realize low total cost of ownership (TCO) by reducing manufacturing costs through simplification of manufacture based on a smart factory production process (a process not involving pressing/vehicle body welding/painting).

In particular, in the case of an unmanned delivery vehicle, it is necessary to develop a vehicle body structure suitable for the unmanned delivery vehicle in order to rapidly cope with various needs in the business-to-business (B2B) market and to enable application thereof to various business models.

That is, it is necessary to appropriately cope with market environments and needs of consumers by reducing manufacturing costs of a vehicle body and achieving simplification of vehicle body production and minimization of development cycle through development of a vehicle body assembly structure suitable for smart factory production.

The above matters disclosed in this section are merely for enhancement of understanding of the general background of the disclosure and should not be taken as an acknowledgement or any form of suggestion that the matters form the related art already publicly known, available, or in use.

### SUMMARY

The present disclosure relates to a body for a vehicle capable of achieving easy and convenient assembly while reducing manufacturing costs through an improved structure thereof meeting characteristics of an unmanned delivery vehicle.

Therefore, some embodiments of the present disclosure has been made in view of the above problems, and some embodiments of the present disclosure can provide a body for a vehicle capable of achieving easy and convenient assembly while reducing manufacturing costs through an improved structure thereof meeting characteristics of an unmanned delivery vehicle.

In accordance with an embodiment of the present disclosure, a body for a vehicle can include a body module including a frame assembled thereto, thereby constituting a frame of the vehicle, an exterior material configured to have a shape covering an outside of the body module, and a mounting unit mounted to the body module, for assembly of the exterior material thereto, a door of the vehicle installed at a position adjacent to the exterior material being pivotably connected to the mounting unit.

The mounting unit may include a first mounting bracket including a mounting part mounted on a mounting seat surface formed at the frame, a hinge connection part formed to be bent in a direction perpendicular to the mounting part such that the door is connected to the hinge connection part through a hinge structure, and a flange part formed to extend from the hinge connection part toward the exterior material such that an exterior bracket formed at the exterior material is assembled to the flange part.

The mounting unit may further include a second mounting bracket including a mounting part mounted on the mounting seat surface, and a hinge connection part formed to be bent in a direction perpendicular to the mounting part. A hinge bracket may be axially coupled, at one end thereof, between the hinge connection part of the first mounting bracket and the hinge connection part of the second mounting bracket by a shaft, and may be fixed to the door at the other end thereof, thereby enabling the door to pivot about the shaft at the one end of the hinge bracket.

A guide hole and a guide pin may be formed at the frame and an inner surface of the exterior material facing the frame, respectively.

The exterior bracket may be assembled to the flange part while overlapping with the flange part in a state of surface-contacting the flange part. A guide may protrude from the flange part while having a shape supporting an edge of the exterior bracket.

The guide may include first portions respectively formed in parallel to each other at upper and lower ends of the flange part, to support upper and lower ends of the exterior bracket, and second portions formed at a portion of the flange part forming a boundary between the flange part and the hinge connection part, to support an end of the exterior bracket.

Each of the second portions may be connected to a corresponding one of the first portions while forming a curved shape.

The second portion may be perpendicularly connected to the corresponding first portion.

The guide may be formed to have a shape corresponding to an edge shape of the exterior bracket overlapping with the flange part.

The exterior bracket may move toward the flange part to overlap with the flange part, and the guide may guide and regulate a movement path of the exterior bracket moving toward the flange part.

The flange part may extend to have a shape inclined to one side with respect to the hinge connection part. The exterior bracket may be formed at the exterior material while having an inclination equal to an inclination of the flange part such that the exterior bracket overlaps with the flange part.

A position regulation hole may be formed at the flange part. A position regulation protrusion configured to be fitted in the position regulation hole may be formed at the exterior bracket, for regulation of a position of the exterior bracket overlapping with the flange part.

A fastener may extend through the flange part and the exterior bracket, thereby fastening the flange part and the exterior bracket.

A nut may be fixed to the flange part, and a bolt may be coupled to the exterior bracket such that the bolt may be fastened to the nut.

### BRIEF DESCRIPTION OF THE DRAWINGS

The above and other features and advantages of the present disclosure can be more clearly understood from the following detailed description taken in conjunction with the accompanying drawings, in which:

FIG. 1 is a perspective view illustrating a vehicle to which an embodiment of the present disclosure is applied;

FIG. 2 is a perspective view showing a side exterior material coupled to the vehicle of FIG. 1, according to an embodiment of the present disclosure;

FIG. 3 is a perspective view showing a body module according to an embodiment of the present disclosure and the side exterior material in an exploded state;

FIG. 4 is a perspective view showing a state in which a hinge bracket is coupled to a mounting unit according to an embodiment of the present disclosure;

FIG. 5 is a perspective view showing a state in which an exterior bracket is not yet assembled to the mounting unit, according to an embodiment of the present disclosure;

FIG. 6 is a perspective view showing a state in which the side exterior material is assembled to the body module according to an embodiment of the present disclosure;

FIG. 7 is a cross-section view showing a structure in which a guide pin of the exterior material is inserted into a guide hole of a frame in accordance with an embodiment of the present disclosure;

FIG. 8 is a perspective view explaining an initial assembly state in which the exterior bracket is begun to overlap with a flange part in accordance with an embodiment of the present disclosure;

FIG. 9 is a cross-sectional view taken along line A-A in FIG. 8, according to an embodiment of the present disclosure;

FIG. 10 is a perspective view explaining an intermediate assembly state in which the exterior bracket overlaps with the flange part in accordance with an embodiment of the present disclosure;

FIG. 11 is a cross-sectional view taken along line B-B in FIG. 10, according to an embodiment of the present disclosure;

FIG. 12 is a perspective view explaining an assembly state in which the exterior bracket completely overlaps with the flange part in accordance with an embodiment of the present disclosure;

FIG. 13 is a cross-sectional view taken along line C-C in FIG. 12, according to an embodiment of the present disclosure;

FIG. 14 is a perspective view showing a state in which the exterior bracket and the flange part are fastened to each other through bolting in accordance with an embodiment of the present disclosure;

FIG. 15 is a cross-sectional view taken along line D-D in FIG. 14, according to an embodiment of the present disclosure; and

FIGS. 16 to 19 are views illustrating various shapes of a guide or a position regulation hole, according to some embodiments of the present disclosure.

### DETAILED DESCRIPTION OF ILLUSTRATIVE EMBODIMENTS

Hereinafter, some example embodiments of the present disclosure will be described in detail with reference to the accompanying drawings, and same or similar elements can be designated by same reference numerals regardless of the numerals in the drawings and redundant description thereof can be omitted.

The suffixes “module” and “unit” of elements herein can be used for convenience of description and thus can be used interchangeably and do not necessarily have any distinguishable meanings or functions.

In the following description of the example embodiments of the present disclosure, a detailed description of known functions and configurations incorporated herein can be omitted when it may obscure the subject matter of the embodiments of the present disclosure. In addition, the example embodiments of the present disclosure can be more clearly understood from the accompanying drawings and should not be necessarily limited by the accompanying drawings, and it can be appreciated that all changes, equivalents, and substitutes that do not depart from the spirit and technical scope of the present disclosure can be encompassed in the present disclosure.

It can be understood that, although the terms “first”, “second”, etc. may be used herein to describe various elements, these elements are not necessarily limited by these terms. These terms can be merely used to distinguish one element from another.

In the case where an element is “connected” or “linked” to another element, it can be understood that the element may be directly connected or linked to the other element, or another element may be present therebetween. Conversely, in the case where an element is “directly connected” or “directly linked” to another element, it can be understood that no other element is present therebetween.

Unless clearly used otherwise, singular expressions can include a plural meaning.

In this specification, the term “comprising”, “including”, or the like, is intended to express the existence of the characteristic, the numeral, the step, the operation, the element, the part, or the combination thereof, and does not exclude another characteristic, numeral, step, operation, element, part, or any combination thereof, or any addition thereto.

Hereinafter, example embodiments of the present disclosure will be described in detail with reference to the accompanying drawings.

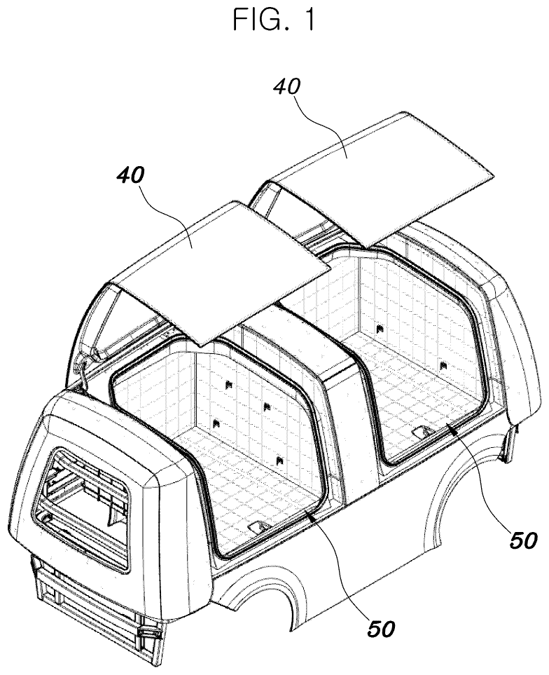

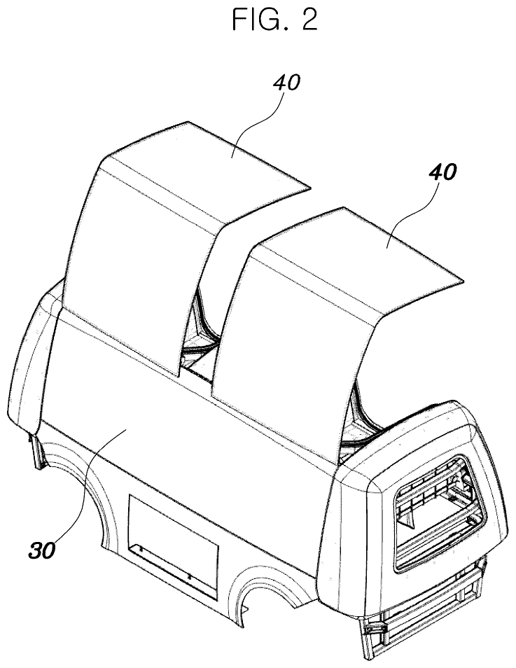

A vehicle applicable to an embodiment of the present disclosure will be described with reference to FIGS. 1 to 3. Referring to FIGS. 1 to 3, a plurality of space frames can constitute a lower body module 20b and an upper body module 20a of a body module 20.

The upper body module 20a can be assembled to an upper portion of the lower body module 20b.

A chassis module including devices such as a power transmission, a brake, a suspension, etc. can be installed at the lower body module 20b.

A luggage module 50 having a space capable of storing goods can be installed in plural at the upper body module 20a. A door 40 functioning to open or close the storage space formed at each luggage module 50 can be installed at the luggage module 50 and, as such, the vehicle may be useful as an unmanned delivery vehicle.

An exterior material 30 can be assembled to outsides of the lower body module 20b and the upper body module 20a.

The exterior material 30 can be a plate-shaped complex material, and may be assembled to the space frames constituting the body module 20.

A body for a vehicle according to an embodiment of the present disclosure can be configured through inclusion of the body module 20, which includes a frame 21 assembled thereto, thereby constituting a frame of the vehicle, the exterior material 30, which can be configured to have a shape covering an outside of the body module 20, and a mounting unit 10 with the exterior material 30 assembled thereto. A door 40 of the vehicle installed at a position adjacent to the exterior material 30 can be pivotably connected to the mounting unit 10.

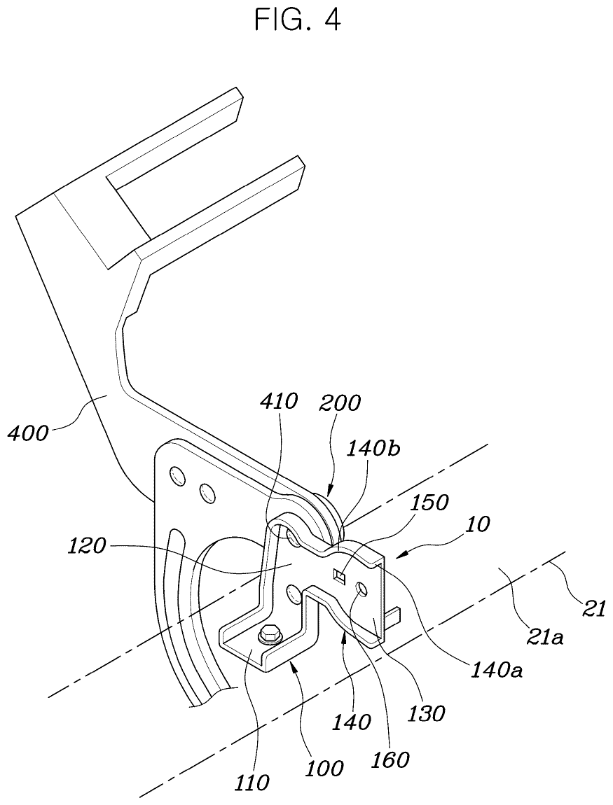

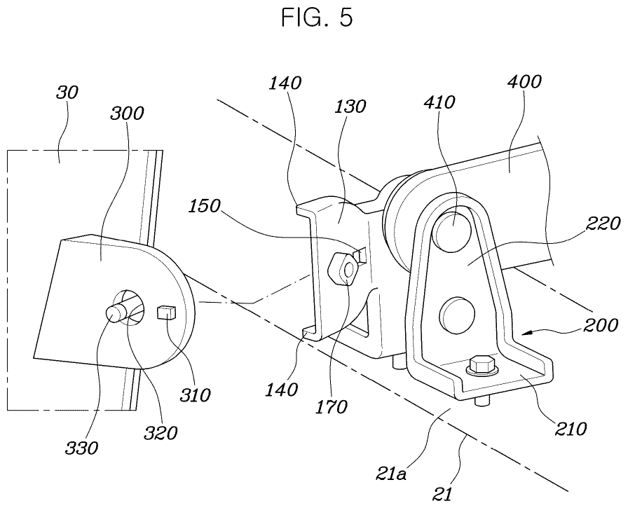

The vehicle body will be described in detail with reference to FIGS. 4 and 5. Referring to FIGS. 4 and 5, a space frame (hereinafter referred to as a “frame 21”) can be assembled to an upper portion of the upper body module 20a at one side of the upper body module 20a in a forward/rearward longitudinal direction, and the mounting unit 10 can be mounted to the frame 21.

A portion of the mounting unit 10 can be formed to extend toward the exterior material 30 to enable the exterior material 30 to be assembled to the mounting unit 10. In addition, the door 40 functioning to open or close a storage space can be coupled to the mounting unit 10 through a hinge structure and, as such, may pivot about the hinge structure.

In the case in which the vehicle has a structure such that the exterior material 30 can be assembled to one side of the upper body module 20a, and a hinge part of the door 40 can be placed adjacent to an upper end of the exterior material 30, interference may occur between a mounting bracket configured to mount the exterior material 30 to the vehicle body and a hinge bracket 400 configured to pivot the door 40 when the mounting bracket and the hinge bracket 400 can be independently installed.

To this end, a scheme for optionally downwardly shifting a position of the mounting bracket may be proposed in order to prevent interference between the mounting bracket and the hinge bracket 400. In this case, however, stiffness of the upper end of the exterior material 30 may be decreased because the distance between the position at which the mounting bracket can be mounted and the upper end of the exterior material 30 can be great under the condition that the mounting bracket is not coupled to the upper end of the exterior material 30.

To this end, in accordance with the present disclosure, the mounting unit 10 can be implemented to integrate a bracket function for mounting the exterior material 30 and a hinge function for the door 40. Accordingly, duplicate parts may be omitted and, as such, manufacturing costs of the vehicle body may be reduced. In addition, the mounting unit 10 may be mounted to the upper end of the exterior material 30 and, as such, desired stiffness of the upper end of the exterior material 30 may be maintained.

In addition, in accordance with the present disclosure, the mounting unit 10 can be configured through inclusion of a first mounting bracket 100 including a mounting part 110 mounted on a mounting seat surface 21a formed at the frame 21, a hinge connection part 120 formed to be bent in a direction perpendicular to the mounting part 110 such that the door 40 can be connected to the hinge connection part 120 through a hinge structure, and a flange part 130 formed to extend from the hinge connection part 120 toward the exterior material 30 such that an exterior bracket 300 formed at the exterior material 30 can be assembled to the flange part 130.

Referring to FIGS. 4 and 5, the frame 21, which can be assembled to the upper part of the upper body module 20a at one side of the upper body module 20a, can be formed to take the form of a member having a closed quadrangular cross-section, and an upper surface of the frame 21 can be formed to have a planar shape and, as such, provides the mounting seat surface 21a.

The mounting part 110, which can have a quadrangular shape, can be formed at a lower end of the first mounting bracket 100 such that the mounting part 110 extends in a direction parallel to the mounting seat surface 21a and, as such, can be assembled to the mounting seat surface 21a through bolting.

In addition, the hinge connection part 120, which can have a triangular shape, can be fixed to an end of the mounting part 110 at one side of the mounting part 110. The hinge connection part 120 can be formed to be upwardly bent in a vertical direction.

In particular, the flange part 130 can be formed at one side of the hinge connection part 120 while having a shape protruding toward the exterior material 30. The exterior bracket 300 can be formed at an inner surface of the exterior material 30 at opposite sides of the exterior material 30 such that the exterior bracket 300 protrudes toward the mounting unit 10.

As the exterior bracket 300 can be assembled to the flange part 130, the exterior material 30 may be assembled to the vehicle while having a shape covering a side surface of the upper body module 20a.

In accordance with assembly of the exterior material 30 to the flange part 130 of the first mounting bracket 100 as well as hinge assembly of the door 40 to the hinge connection part 120 of the first mounting bracket 100, the function for mounting the exterior material 30 and the hinge function of the door 40 can be integrated through the first mounting bracket 100 (e.g., one part).

Accordingly, the number of parts may be reduced and, as such, manufacturing costs may be reduced.

In addition, in accordance with an embodiment of the present disclosure, the mounting unit 10 can be configured through further inclusion of a second mounting bracket 200 including a mounting part 210 mounted on the mounting seat surface 21a, and a hinge connection part 220 can be formed to be bent in a direction perpendicular to the mounting part 210.

The hinge bracket 400 can be axially coupled, at one end thereof, between the hinge connection part 120 of the first mounting bracket 100 and the hinge connection part 220 of the second mounting bracket 200 by a shaft 410, and the hinge bracket 400 can be fixed to the door 40 at the other end thereof. Accordingly, the door 40 may pivot about the shaft 410 at the one end of the hinge bracket 400.

Referring to FIGS. 4 and 5, the second mounting bracket 200 can be assembled, through bolting, to the mounting seat surface 21a to which the first mounting bracket 100 can be assembled. The second mounting bracket 200 can be installed at a position symmetrical to that of the first mounting bracket 100 under the condition that the hinge bracket 400 can be interposed between the first mounting bracket 100 and the second mounting bracket 200.

In more detail, the mounting part 210, which can have a quadrangular shape, can be formed at a lower end of the second mounting bracket 200 such that the mounting part 210 can extend in a direction parallel to the mounting seat surface 21a. The mounting part 210 can be assembled to the mounting seat surface 21a through bolting.

In addition, the hinge connection part 220, which can have a triangular shape, can be fixed to an end of the mounting part 210 of the second mounting bracket 200 at one side of the mounting part 210. The hinge connection part 220 can be formed to be upwardly bent in a vertical direction.

The hinge connection part 220 of the second mounting bracket 200 can be configured to face the hinge connection part 120 of the first mounting bracket 100. The hinge bracket 400 can be axially coupled to upper ends of the opposite hinge connection parts 120 and 220 by the shaft 410.

In addition, as the hinge bracket 400 can be fixed to the door 40, the door 40 may pivot about the shaft 410 at the upper ends of the hinge connection parts 120 and 220, together with the hinge bracket 400. Accordingly, the door 40 may operate to be opened or closed.

As the hinge bracket 400 can be coupled between the first mounting bracket 100 and the second mounting bracket 200 through a hinge structure such that the hinge bracket 400 may pivot, as described above, connection stiffness of the hinge bracket 400 can be enhanced and, as such, pivoting of the door 40 may be stably carried out.

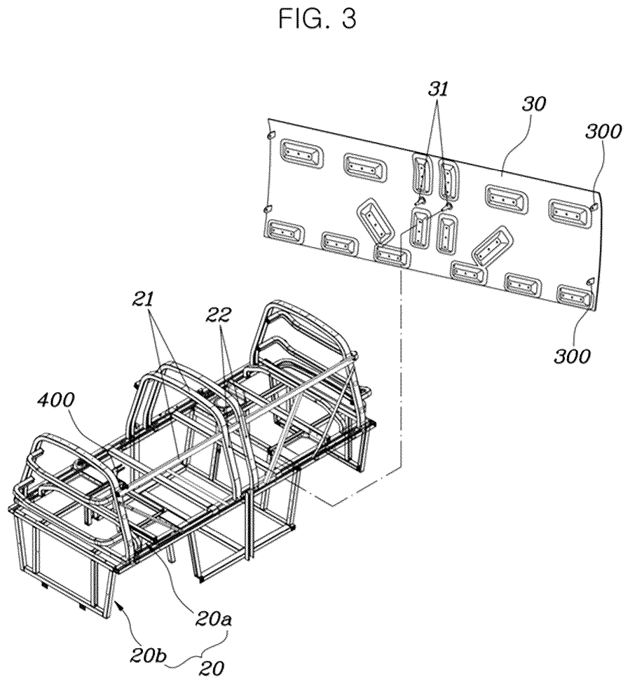

Referring to FIG. 3, in accordance with an embodiment of the present disclosure, a guide hole 22 and a guide pin 31 may be formed at the frame 21 and the inner surface of the exterior material 30 facing the frame 21, respectively.

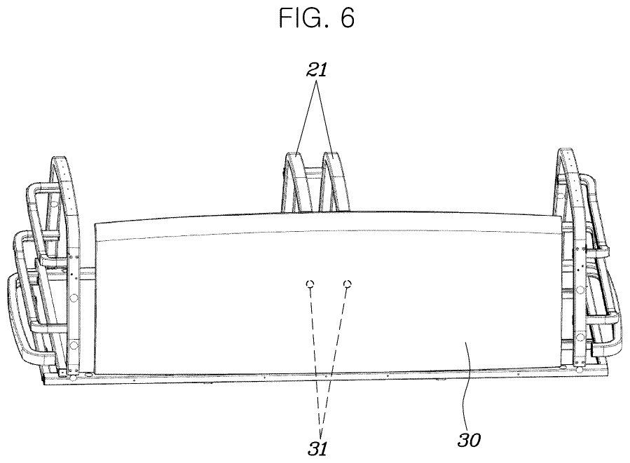

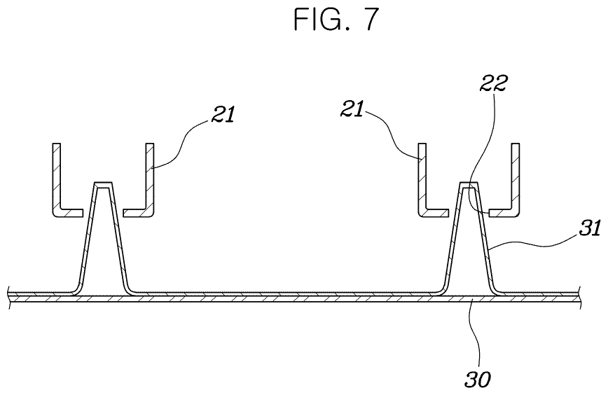

Referring to FIGS. 3, 6, and 7, a frame, which can be formed to have an inverted-U shape in a lateral direction of the vehicle, may be assembled to a middle portion of the upper body module 20a. The inverted-U-shaped frame 21 may be assembled between front and rear luggage modules 50 to partition the front and rear luggage modules 50 from each other.

In particular, the guide hole 22 can be formed at one side surface facing the exterior material 30 from among opposite side surfaces of the frame 21, and the guide pin 31 can be formed at the inner surface of the exterior material 30 facing the guide hole 22.

Accordingly, when the exterior material 30 is moved toward the upper body module 20a, for assembly thereof to the upper body module 20a, the guide pin 31 can guide the exterior material 30 to an assembly position thereof while being inserted into the guide hole 22.

In accordance with an embodiment of the present disclosure, the exterior bracket 300 can be assembled to the flange part 130 under the condition that the exterior bracket 300 overlaps with the flange part 130 in a state of surface-contacting the flange part 130. A guide 140 can protrude from the flange part 130 to have a shape supporting an edge of the exterior bracket 300.

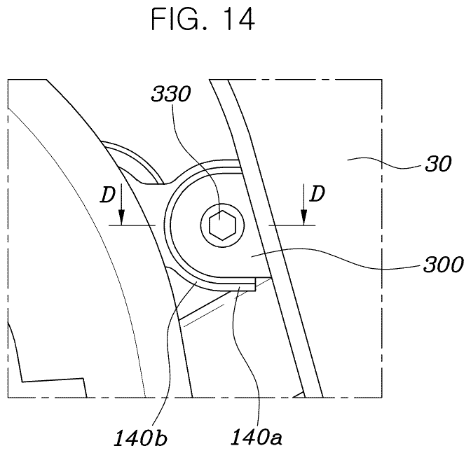

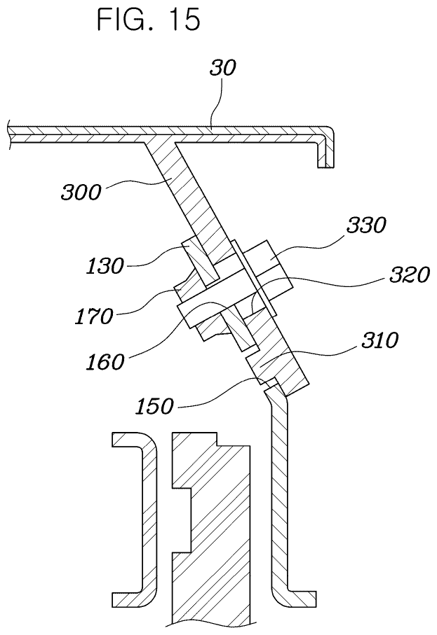

As shown in FIGS. 14 and 15, an inner surface of the exterior bracket 300 surface-can contacts an outer surface of the flange part 130, and the guide 140 can protrude from an edge of the flange part 130 to surround the edge of the exterior bracket 300.

Accordingly, the exterior bracket 300 surface-contacting the flange part 130 can be prevented from moving in a direction horizontally parallel to a contact surface of the flange part 130 and, as such, an assembly position of the exterior bracket 300 can be regulated.

In detail, the guide 140 can be configured through inclusion of first portions 140a respectively formed in parallel to each other at upper and lower ends of the flange part 130, to support upper and lower ends of the exterior bracket 300, and second portions 140b can be formed at a portion of the flange part 130 forming a boundary between the flange part 130 and the hinge connection part 120, to support an end of the exterior bracket 300.

Referring to FIGS. 4 and 14, the flange part 130 can be formed to protrude from a side surface of the hinge connection part 120 in the lateral direction of the vehicle, that is, an L-direction. In this case, the exterior bracket 300 can be also formed to protrude in the lateral direction of the vehicle, that is, the L-direction.

In addition, the first portions 140a and the second portions 140b can be formed along upper and lower edges of the flange part 130 extending from the hinge connection part 120, respectively.

In particular, the first portions 140a can be formed at the upper and lower ends of the flange part 130 facing the exterior bracket 300, to extend in the lateral direction of the vehicle, respectively.

Accordingly, when the exterior bracket 300 moves in a direction in which the exterior bracket 300 overlaps with the flange part 130, for assembly thereof to the flange part 130, the exterior bracket 300 can be guided between the first portions 140a of the flange part 130 while moving. Accordingly, movement of the exterior bracket 300 in upward and downward directions can be prevented or regulated.

Thus, a loading direction of the exterior material 30 moving toward the body module 20 during assembly of the exterior material 30 can be easily guided. Accordingly, assemblability of the exterior material 30 may be enhanced and, as such, productivity may be enhanced.

In addition, the second portions 140b can be formed to extend toward the hinge connection part 120 while being connected to the first portions 140a, respectively, and as such, can be formed to have a shape blocking the end of the exterior bracket 300 at the side of the hinge connector 120.

Accordingly, the exterior bracket 300 can be overlapping with the flange part 130 and can be blocked by the second portions 140b and, as such, excessive movement of the exterior bracket 300 can be prevented.

In an embodiment of the guide 140, each second portion 140b may be connected to a corresponding one of the first portions 140a while forming a curved shape.

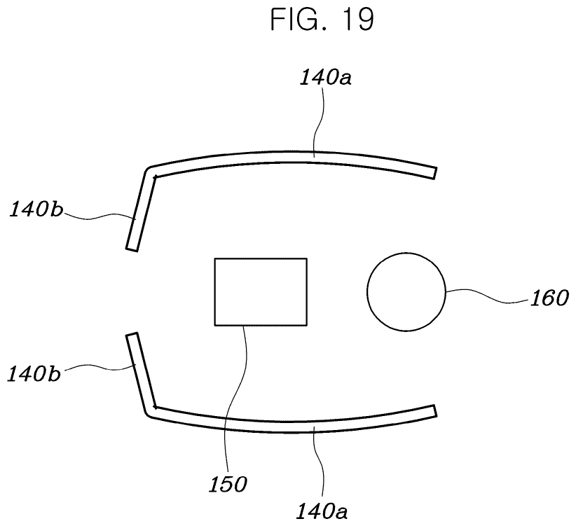

That is, as shown in FIGS. 4 and 19, the second portions 140b extending from the first portions 140a can be formed at the upper and lower ends of the flange part 130 toward the hinge connection part 120, respectively, and may be formed to have an arc shape or a curved shape.

In an embodiment of the guide 140, each second portion 140b may be perpendicularly connected to the corresponding first portion 140a.

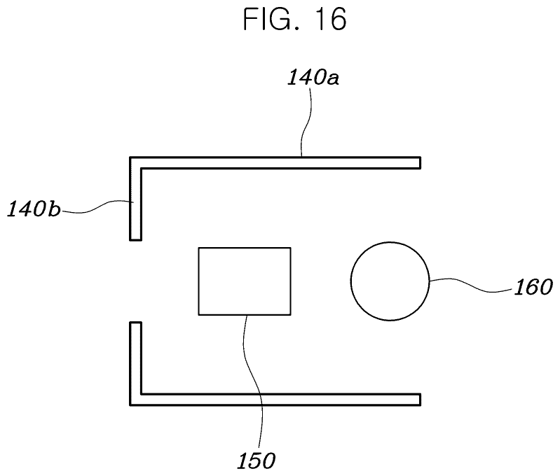

That is, as shown in FIGS. 16 to 18, the second portions 140b extending from the first portions 140a formed at the upper and lower ends of the flange part 130 toward the hinge connection part 120, respectively, may be formed in a direction perpendicular to the first portions 140a, respectively.

In addition, the guide 140 may be formed to have a shape corresponding to an edge shape of the exterior bracket 300 overlapping with the flange part 130.

That is, as shown in FIG. 14, each second portion 140b can be formed to be connected to the corresponding first portion 140a while forming a curved shape to support the exterior bracket 300 under the condition that the second portion 140b surface-contacts the edge of the exterior bracket 300 while surrounding the edge of the exterior bracket 300.

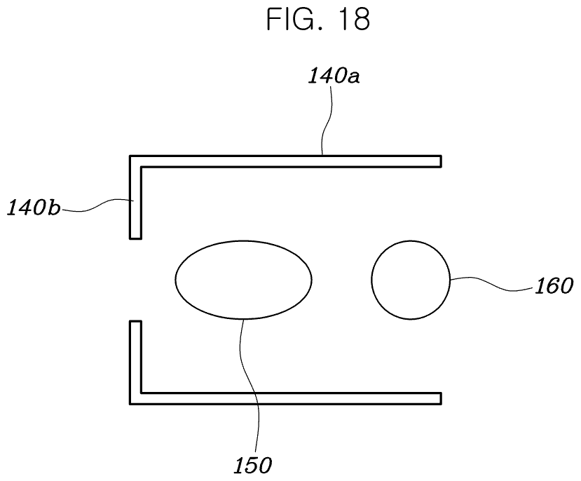

In addition, because each second portion 140b can be formed to have a shape perpendicularly connected to the corresponding first portion 140a in the case of the guide 140 formed as shown in FIGS. 16 and 18, the edge of the exterior bracket 300 can be overlapping with the guide 140 and can be formed to have a shape corresponding to the shape of the guide 140.

Furthermore, the exterior bracket 300 may overlap with the flange part 130 in accordance with movement thereof toward the flange part 130, and the guide 140 may guide and regulate a movement path of the exterior bracket 300 moving toward the flange part 130.

That is, for assembly of the exterior material 30 to the body module 20, the exterior bracket 300 can be assembled to the flange part 130 in a fitting manner while being shifted in the L-direction toward the flange part 130.

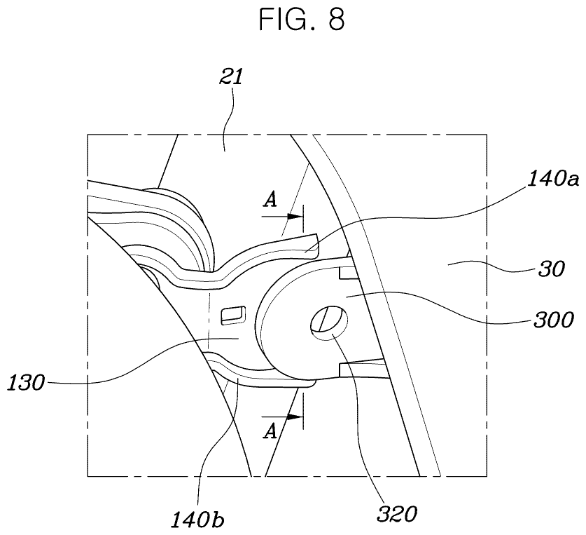

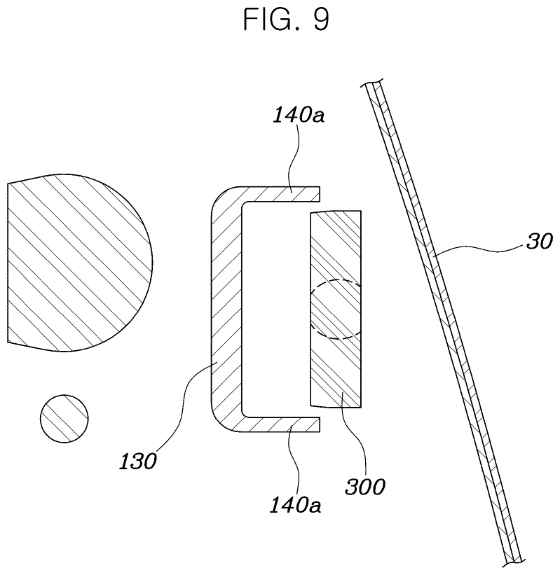

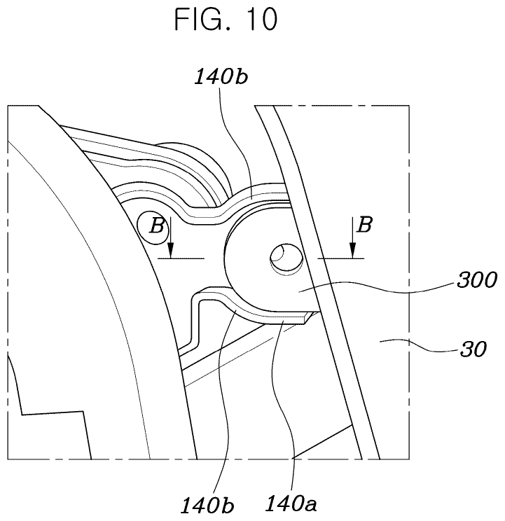

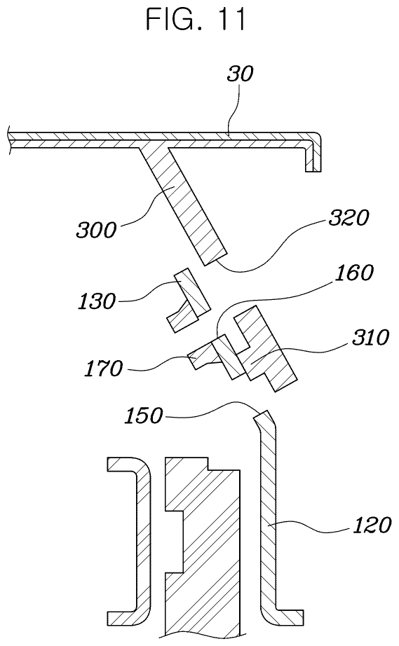

In detail, as shown in FIGS. 8 to 13, the exterior bracket 300 moves while being guided by the first portions 140a formed at the upper and lower ends of the flange part 130 from an initial assembly step in which the exterior bracket 300 can begin to overlap with the flange part 130 to a movement ending step in which the exterior bracket 300 further moves until movement thereof is ended. Accordingly, the guide 140 can accurately and stably guide the movement path of the exterior bracket 300.

Accordingly, movement of the exterior bracket 300 in the L-direction in which the exterior bracket 300 can be assembled to the flange part 130 may be easily guided by the first portions 140a under the condition that movement of the exterior bracket 300 in a vertical direction, that is, an H-direction, can be prevented or regulated. Thus, assemblability of the exterior material 30 may be enhanced.

Furthermore, in accordance with an embodiment of the present disclosure, the flange part 130 may be formed to extend to have a shape inclined toward one side with respect to the hinge connection part 120, and the exterior bracket 300 may be formed at the exterior material 30 while having the same inclination as that of the flange part 130 such that the exterior bracket 300 may overlap with the flange part 130.

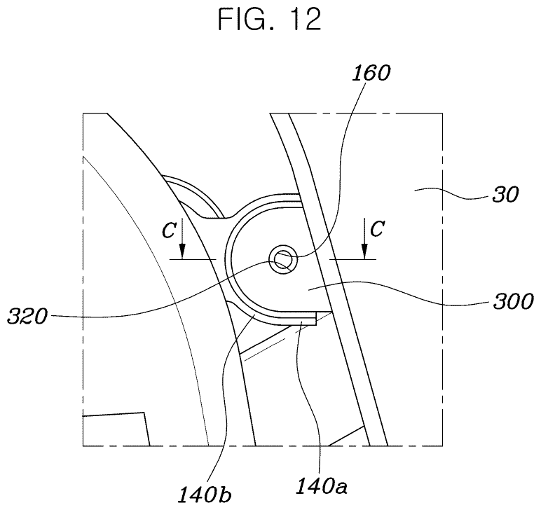

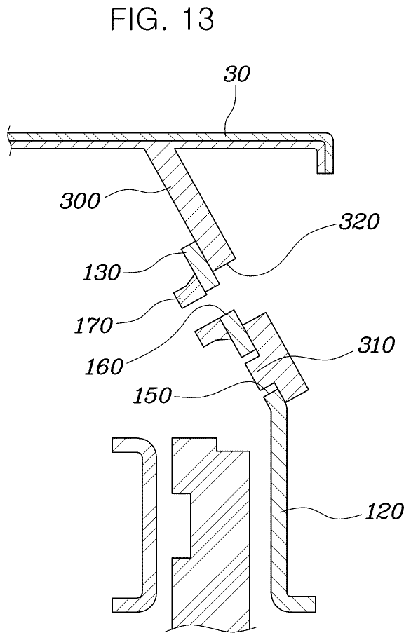

This will be described with reference to FIGS. 12 and 13. Referring to FIGS. 12 and 13, the hinge connection part 120 may be formed in a direction perpendicular to the exterior material 30, and the flange part 130 may be extending from the hinge connection part 120 and may be formed to have a shape inclined toward a center of the exterior material 30.

In addition, the exterior bracket 300 may be formed to have a shape inclined in a direction outwardly far from the center of the exterior material 30. The exterior bracket 300 and the flange part 130 may be formed to have the same inclination.

Accordingly, when the exterior bracket 300 is shifted toward the flange part 130, for assembly of the exterior material 30 to the body module 20, an inclined inner surface of the exterior bracket 300 may overlap with an inclined outer surface of the flange part 130 in a state of surface-contacting the inclined outer surface of the flange part 130 and, as such, assembly of the exterior material 30 to the body module 20 may be achieved.

For reference, the exterior bracket 300 can be provided at left and right sides of the exterior material 30 such that left and right exterior brackets 300 can be symmetrical with each other. The flange part 130 may be provided at left and right sides of the body module 20 such that left and right flange parts 130 can be assembled to the left and right exterior brackets 300, respectively.

In addition, in accordance with an embodiment of the present disclosure, a position regulation hole 150 may be formed at the flange part 130, and a position regulation protrusion 310 can be configured to be fitted in the position regulation hole 150 and may be formed to have a protrusion structure. Accordingly, a position of the exterior bracket 300 overlapping with the flange part 130 may be regulated.

That is, as shown in FIGS. 12 and 13, the position regulation protrusion 310 can be fitted in the position regulation hole 150 in a state in which the exterior bracket 300 completely overlaps with the flange part 130. Accordingly, it may be possible to more securely prevent movement of the exterior bracket 300 in the L-direction and the H-direction.

The outer surface of the position regulation protrusion 310 can have a same cross-sectional shape as that of the inner surface of the position regulation hole 150. When the outer surface of the position regulation protrusion 310 has a quadrangular cross-sectional shape, the inner surface of the position regulation hole 150 may also be formed to have a quadrangular cross-sectional shape, for example.

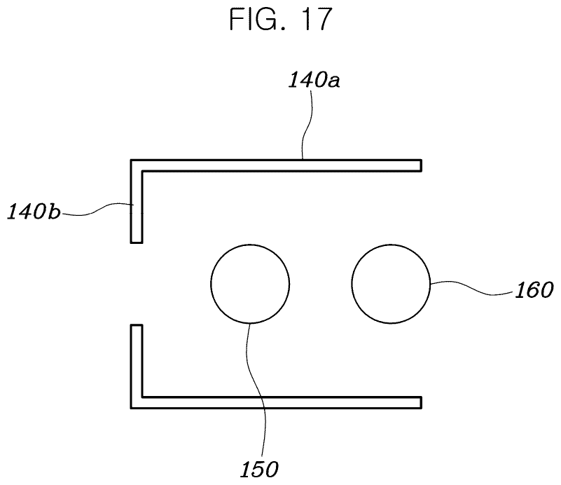

Alternatively, when the outer surface of the position regulation protrusion 310 has a circular or oval cross-sectional shape, as shown in FIGS. 17 and 18, the inner surface of the position regulation hole 150 may also be formed to have a circular or oval cross-sectional shape, for example.

For reference, in accordance with an embodiment of the present disclosure, when the exterior bracket 300 is shifted toward the flange part 130, for assembly of the exterior material 30 to the body module 20, the position regulation protrusion 310 can be moved along the inclined surface of the flange part 130 because the flange part 130 and the exterior bracket 300 can be inclinedly formed at a predetermined inclination. The position regulation protrusion 310 moves under the condition that the exterior bracket 300 and the flange part 130 can be bent in an elastic range thereof in accordance with elasticity thereof.

Accordingly, the position regulation protrusion 310 can be fitted in the position regulation hole 150 while moving without being caught by the flange part 130.

In accordance with the present disclosure, the flange part 130 and the exterior bracket 300 may be fastened to each other by a fastener extending therethrough.

A fastener may extend through middle portions of the flange part 130 and the exterior bracket 300 in a state in which the flange part 130 and the exterior bracket 300 completely overlap each other, thereby fastening the flange part 130 and the exterior bracket 300 to each other.

A nut 170 may be fixed to the flange part 130, and a bolt 330 may be coupled to the exterior bracket 300 such that the bolt 330 may be fastened to the nut 170.

In detail, as shown in FIGS. 14 and 15, a fixing hole 160 can be formed at the middle portion of the flange part 130, and the nut 170 can be fixed in the fixing hole 160. In addition, a bolting hole 320 can be formed at the exterior bracket 300.

The bolt 330 can be inserted into the bolting hole 320 in a direction perpendicular to the exterior bracket 300 in a state in which the flange part 130 and the exterior bracket 300 completely overlap each other. The bolt 330 can be then fastened to the nut 170 and, as such, assembly between the exterior bracket 300 and the flange part 130 can be completed.

As apparent from the above description, the mounting unit 10 can be implemented to integrate a bracket function for mounting the exterior material 30 and a hinge function for the door 40. Accordingly, duplicate parts may be omitted and, as such, manufacturing costs of the vehicle body may be reduced. In addition, the mounting unit 10 may be mounted to the upper end of the exterior material 30 and, as such, desired stiffness of the upper end of the exterior material 30 may be maintained.

Furthermore, a loading direction of the exterior material 30 moving toward the body module 20 during assembly of the exterior material 30 can be easily guided by the guide 140. Accordingly, assemblability of the exterior material 30 may be enhanced and, as such, productivity may be enhanced.

Although some example embodiments of the present disclosure have been disclosed for illustrative purposes, those skilled in the art can appreciate that various modifications, additions, and substitutions are possible, without departing from the scope and spirit of the disclosure as disclosed in the accompanying claims.

What is claimed is:

1. A body for a vehicle comprising:
a body module comprising a frame;
an exterior material configured to have a shape covering an outside of the body module;
a mounting unit mounted to the body module, wherein the exterior material is assembled to the body module via the mounting unit; and
a door installed at a position adjacent to the exterior material to be pivotably connected to the mounting unit.

2. The body of claim 1, wherein the mounting unit includes a first mounting bracket, and the first mounting bracket comprises:
a first mounting part mounted on a mounting seat surface of the frame;
a first hinge connection part formed to be bent in a direction perpendicular to the first mounting part such that the door is connected to the first hinge connection part through a first hinge structure; and
a flange part formed to extend from the first hinge connection part toward the exterior material such that an exterior bracket formed at the exterior material is assembled to the flange part.

3. The body of claim 2, wherein the mounting unit further includes a second mounting bracket, and the second mounting bracket comprises:
a second mounting part mounted on the mounting seat surface, and
a second hinge connection part formed to be bent in a direction perpendicular to the second mounting part; and
a hinge bracket is axially coupled, at one end thereof, between the first hinge connection part of the first mounting bracket and the second hinge connection part of the second mounting bracket by a shaft, and is fixed to the door at another end thereof opposite to the one end, thereby enabling the door to pivot about the shaft at the one end of the hinge bracket.

4. The body of claim 2, further comprising:
a guide hole formed at the frame; and
a guide pin protruding from an inner surface of the exterior material facing the frame.

5. The body of claim 2, wherein the exterior bracket is assembled to the flange part while overlapping with the flange part in a state of surface-contacting the flange part, and wherein a guide protrudes from the flange part, the guide having a shape configured to support an edge of the exterior bracket.

6. The body of claim 5, wherein the guide comprises:
first portions formed in parallel to each other at upper and lower ends of the flange part, configured to support upper and lower ends of the exterior bracket; and
second portions formed at a portion of the flange part forming a boundary between the flange part and the second hinge connection part, configured to support an end of the exterior bracket.

7. The body of claim 6, wherein each of the second portions is connected to a corresponding one of the first portions while forming a curved shape.

8. The body of claim 6, wherein each of the second portions is perpendicularly connected to a corresponding one of the first portions.

9. The body of claim 5, wherein the guide is formed to have a shape corresponding to an edge shape of the exterior bracket overlapping with the flange part.

10. The body of claim 5, wherein the exterior bracket and the flange part are configured such that as the exterior bracket moves toward the flange part to overlap with the flange part during assembly, the guide guides and regulates a movement path of the exterior bracket moving toward the flange part.

11. The body of claim 5, wherein the flange part extends at an inclined angle relative to the first hinge connection part, and wherein
the exterior bracket is formed at the exterior material extending at the inclined angle such that the exterior bracket overlaps with the flange part.

12. The body of claim 2, further comprising:
a position regulation hole at the flange part; and
a position regulation protrusion at the exterior bracket, wherein the position regulation protrusion is configured to be fitted in the position regulation hole for regulation of a position of the exterior bracket overlapping with the flange part.

13. A vehicle comprising:
a frame;
an exterior material configured to partially cover the frame;
a door; and
a bracket assembly including a first bracket portion, a second bracket portion, a third bracket portion, and a fourth bracket portion,
wherein the first bracket portion has a first bottom portion configured to seat on a surface of the frame and the first bottom portion being removably attached to the frame, the first bracket portion having a first upright portion at a first angle relative to the first bottom portion, wherein the first upright portion has a first hinge hole therein, the first bracket portion having a first side portion extending laterally from the first upright portion at a second angle,
wherein the second bracket portion extending from the exterior material, the second bracket portion and the first side portion of the first bracket portion being configured to mate, such that the exterior material is attached to the frame via the second bracket portion and the first side portion of the first bracket portion,
wherein the third bracket portion has a third bottom portion configured to seat on the surface of the frame and the third bottom portion being removably attached to the frame, the third bracket portion having a third upright portion at a third angle relative to the third bottom portion, wherein the third upright portion has a second hinge hole therein, and
wherein the fourth bracket portion has a third hinge hole therein, the door being attached to the frame via the fourth bracket portion, wherein a hinge shaft extends through the first hinge hole, the second hinge hole, and the third hinge hole, such that the door is pivotably coupled to the frame, and such that the door is adjacent the exterior material in a closed position.

14. The vehicle of claim 13, wherein the first side portion of the first bracket portion has guides protruding perpendicular to a mating surface, wherein the guides have a shape matching at least part of an exterior shape of the second bracket portion.

15. The vehicle of claim 13, wherein the first side portion of the first bracket portion has a position regulation hole, wherein the second bracket portion has a position regulation protrusion, and wherein the position regulation protrusion fits into the position regulation hole.

16. The vehicle of claim 13, wherein the first angle is 90 degrees, the second angle is inclined, and the third angle is 90 degrees.

17. A vehicle comprising:
a frame;
an exterior material configured to partially cover the frame;
a door; and
a bracket assembly including a first bracket portion, a second bracket portion, a third bracket portion, and a fourth bracket portion,
wherein the first bracket portion has a first bottom portion configured to seat on a surface of the frame and the first bottom portion being removably attached to the frame, the first bracket portion having a first upright portion at a first angle relative to the first bottom portion, wherein the first upright portion has a first hinge hole therein, the first bracket portion having a first side portion extending laterally from the first upright portion at a second angle,
wherein the second bracket portion extending from the exterior material, the second bracket portion and the first side portion of the first bracket portion being configured to mate, such that the exterior material is attached to the frame via the second bracket portion and the first side portion of the first bracket portion,
wherein the third bracket portion has a third bottom portion configured to seat on the surface of the frame and the third bottom portion being removably attached to the frame, the third bracket portion having a third upright portion at a third angle relative to the third bottom portion, wherein the third upright portion has a second hinge hole therein, and
wherein the fourth bracket portion has a third hinge hole therein, the door being attached to the frame via the fourth bracket portion, wherein a hinge shaft extends through the first hinge hole, the second hinge hole, and the third hinge hole, such that the door is pivotably coupled to the frame, and such that the door is adjacent the exterior material in a closed position,
wherein the first side portion of the first bracket portion has guides protruding perpendicular to a mating surface, wherein the guides have a shape matching at least part of an exterior shape of the second bracket portion, and
wherein the first side portion of the first bracket portion has a position regulation hole, wherein the second bracket portion has a position regulation protrusion, and wherein the position regulation protrusion fits into the position regulation hole.
